(19) United States
(12) Patent Application Publication
(10) Pub. No.: US 2008/0206415 A1
(43) Pub. Date: Aug. 28, 2008

(54) PROTEIN BEVERAGE AND METHOD OF MAKING THE SAME

(75) Inventors: Shawn Sherwood, Carlsbad, CA (US); Steven Anthony Rittmanic, Chandler, AZ (US); David A. Jenkins, Carlsbad, CA (US)

Correspondence Address: DUCKOR SPRADLING METZGER & WYNNE;A LAW CORPORATION, 3043 4th Ave., SAN DIEGO, CA, 92103, US

(73) Assignee: NEXT Proteins, Inc.

(21) Appl. No.: 12/110,263

(22) Filed: Apr. 25, 2008

Related U.S. Application Data
(63) Continuation-in-part of application No. 11/215,524, filed on Aug. 30, 2005, now Pat. No. 7,205,018.
Application No. 11/215,524 is a continuation-in-part of application No. 11/373,412, filed on Mar. 10, 2006.
Application No. 11/373,412 is a continuation-in-part of application No. 11/683,338, filed on Mar. 7, 2007.
Application No. 11/683,338 is a continuation-in-part of application No. 11/683,375, filed on Mar. 7, 2007.
Application No. 11/683,375 is a continuation-in-part of application No. 11/683,380, filed on Mar. 7, 2007.
Application No. 11/683,380 is a continuation-in-part of application No. 11/685,641, filed on Mar. 13, 2007.
(60) Provisional application No. 60/617,146, filed on Oct. 7, 2004.
(60) Provisional application No. 60/648,914, filed on Jan. 31, 2005.
(60) Provisional application No. 60/648,974, filed on Jan. 31, 2005.
(60) Provisional application No. 60/956,663, filed on Aug. 17, 2007.
(60) Provisional application No. 60/975,500, filed on Sep. 26, 2007.

(51) Int. Cl. A23L 2/66; A23L 2/44; A23L 2/52

(52) U.S. Cl. 426/326; 426/590; 426/599; 426/592; 426/477; 426/519; 426/329; 426/330.3; 426/330.5; 426/598; 426/656; 426/657; 426/392; 426/385

(57) ABSTRACT

A protein beverage composition and a method of making it relate to a beverage including a protein essentially free of caseinate and derived from an aqueous protein isolate collected from membrane-filtration isolation of the protein and without substantial drying the protein beverage composition exhibits a pH ranging from about 2.0 to about 4.6. Substantial solubility of the protein is maintained in the beverage composition, and the protein beverage is essentially free of active microbes known to be harmful to human health, both at the time of packaging of the protein beverage and for a time period of at least one year after packaging.

### RELATED APPLICATIONS

This Application is related to U.S. Pat. No. 7,205,018 B2, filed Aug. 30, 2005 as U.S. patent application Ser. No. 11/215,524, issued Apr. 17, 2007, and entitled “Carbonated Protein Drink and Method of Making,” which is related to U.S. Provisional Patent Application Ser. No. 60/617,146, filed Oct. 7, 2004, and entitled: “Carbonated Whey Protein Beverage;” U.S. Provisional Patent Application Ser. No. 60/648,914, filed Jan. 31, 2005, and entitled: “Carbonated Aqueous Whey Protein Beverage and Method of Making Same;” and, U.S. Provisional Patent Application Ser. No. 60/648,974, filed Jan. 31, 2005, and entitled: “Dry Carbonated Whey Protein Beverage and Method of Making Same.”

This Application claims priority to the following: U.S. Provisional Patent Application Ser. No. 60/956,663, filed Aug. 17, 2007, and entitled: “Protein Beverage and Method of Making the Same”; U.S. Provisional Patent Application Ser. No. 60/975,500, filed Sep. 26, 2007, and entitled “Protein Beverage and Method of Making the Same”; U.S. patent application Ser. No. 11/373,412, filed Mar. 10, 2006, and entitled “High Energy Carbonated Protein Drink and Method of Making”, which is a Continuation-In-Part Patent Application of U.S. Pat. No. 7,205,018 B2; U.S. patent application Ser. No. 11/683,338, filed Mar. 7, 2007, and entitled “Protein Beverage and Method of Making the Same”, which is a Continuation-In-Part Patent Application of U.S. Pat. No. 7,205,018 B2; U.S. patent application Ser. No. 11/683,375, filed Mar. 7, 2007, and entitled “Protein Beverage and Method of Making the Same”, which is a Continuation-In-Part Patent Application of U.S. Pat. No. 7,205,018 B2; U.S. patent application Ser. No. 11/683,380, filed Mar. 7, 2007, and entitled “Protein Beverage and Protein Beverage Concentrate and Methods of Making the Same”, which is a Continuation-In-Part Patent Application of U.S. Pat. No. 7,205,018 B2; U.S. patent application Ser. No. 11/685,641, filed Mar. 13, 2007, and entitled “Carbonated Protein Drink and Method of Making”, which is a Continuation Application of U.S. Pat. No. 7,205,018 B2. Each of these Patent Applications is hereby incorporated by reference in its entirety.

### BACKGROUND OF THE INVENTION

1. Field of the Invention

The present invention pertains to a protein beverage and protein beverage concentrate, and to methods of making the protein beverage and protein beverage concentrate.

2. Brief Description of the Background Art

This section describes background subject matter related to the disclosed embodiments of the present invention. There is no intention, either express or implied, that the background art discussed in this section legally constitutes prior art. Moreover, this brief description is not intended to fully describe the subject matter of this art, the reader is invited to more thoroughly examine the background to better understand what is disclosed.

Milk contains two major protein fractions, casein, which may provide about 80% by weight of the total protein, and whey protein, which may provide about 20% by weight of the total protein. The whey protein fraction is the protein fraction which may remain soluble when the casein fraction is coagulated (such, for example, as by either enzyme or acid) and separated as cheese curd. Whey protein may include several protein fractions, including, for example, β-lactoglobulin, α-lactoglobulin, Lactalbumin, immunoglobulins (such as IgG1, IgG2, IgA, and IgM, for example), lactoferrin, glycomacropeptides, and lactoperoxidase.

Compared to casein and soy, whey proteins may be highly soluble. Whey proteins may be the least soluble at typically about pH 4.5 to about pH 5.5, which may be the isoelectric point (the pH at which the net electrical charge is zero) for whey protein. In higher acid systems with a pH less than about 4.5, such as in many carbonated beverages, the acid solubility of whey proteins may be especially important; however, protein precipitation may occur during the mixing period when the pH of the whey protein, which typically has a pH of about 6 to about 7, transitions through the zone of isoelectric points. Protein solubility may be affected by heat, and therefore the elevated temperatures experienced during pasteurization may also negatively affect solubility and fluidity resulting in protein precipitation or gelation.

Whey protein may have a higher biological value and/or protein digestibility corrected amino acid score (PDCAAS) than casein. The physical properties of whey proteins in the digestive tract may be quite distinct from the properties of casein. Caseins may form curds within the stomach, which curds may be slow to exit from the stomach and which curds may increase their hydrolysis prior to entering the small intestine. Alternatively, whey proteins may reach the jejunum almost immediately; however their hydrolysis within the intestine may be slower than that of caseins, so their digestion and absorption may occur over a greater length of the intestine.

The protein efficiency ratio (PER) of a protein source measures the weight gain of young animals per gram of protein eaten over a given time period. Any protein having a PER of 2.5 is considered good quality. Whey protein is considered to be a nutritionally excellent protein, as it has a PER of 3.2. Casein has a PER of 2.5, while many commonly used proteins have a PER of less than 2.5, such as soy protein (PER 2.2), corn protein (PER 2.2), peanut protein (PER 1.8), and wheat gluten (PER 0.8). The higher PER of whey protein may be due in part to the high level of sulfur-containing amino acids in whey protein. Such higher level may contribute to whey protein's ability to enhance immune-function and antioxidant status.

Whey protein is a rich source of branched chain amino acids (BCAAs), containing the highest known levels of any natural food source. BCAAs are important for athletes, since, unlike the other essential amino acids, they are metabolized directly into muscle tissue and are the first amino acids used during periods of exercise and resistance training. Leucine may be important for athletes as it may play a key role in muscle protein synthesis and lean muscle support and growth. Research suggests that individuals who exercise benefit from diets high in leucine and may have more lean muscle tissue and less body fat than individuals whose diet contains lower levels of leucine. Whey protein isolate may have approximately 45% by weight more leucine than soy protein isolate.

Whey protein is available in several forms, with preparations which may range from about 1% to about 99% whey protein. Whey protein preparations may be in an aqueous form created by the removal of casein, but often takes several other forms, such as, for example, but not by way of limitation, a whey protein extract, whey protein concentrate, whey protein isolate, or whey protein hydrolysate.

Whey protein concentrate may be prepared by removing sufficient non-protein constituents from whey by membrane filtration, so that the finished dry product may be selected to contain whey protein at a given concentration which may range from about 25% by weight to about 89.9% by weight protein.

Whey protein isolate may be obtained by removing sufficient non-protein constituents from whey by membrane filtration or ion exchange absorption, so that the finished dry product may contain about 90% by weight or more whey protein, and little, if any, fat, cholesterol, or carbohydrates (e.g., lactose). Prior to concentration and spray drying, aqueous whey protein isolate (WPIaq) may have a whey protein concentration of about 1% by weight to about 35% by weight, and may also be essentially free of fat, cholesterol, and carbohydrates.

Whey protein hydrolysate is a whey protein preparation which may have been subjected to enzymatic digestion with a protease enzyme or limited acid hydrolysis, or a suitable mechanical breakage of peptide bonds to form smaller peptides and polypeptides. The protein concentration of the whey protein hydrolysate may be dependent upon the starting material. For example, a whey protein hydrolysate prepared from an 80% by weight whey protein concentrate may have an 80% by weight protein concentration, and a whey protein hydrolysate prepared from a 90% by weight whey protein isolate may have a 90% by weight protein concentration. Not all hydrolyzed whey proteins may behave alike in a food formulation, and thus one hydrolyzed whey protein may not be interchangeable with another. The functional and biological properties of whey protein hydrolysates may vary depending upon factors, such as degree of hydrolysis and which protease enzyme is used for hydrolysis.

Although hydrolysis of whey protein may lead to increased solubility, it may also negatively impact the taste. Whey protein typically has a fresh, neutral taste which may allow it to be included in other foods without adversely affecting the taste. However, hydrolysis of whey protein may result in a very bitter taste, which may impose a practical limit on the amount of whey protein hydrolysate that can be used in a food product. Therefore, a high protein beverage made with whey protein hydrolysate may require a large amount of sweeteners, or bitter masking agents to overcome the bitter taste. However, such a large amount of sweetener may not be desirable to many consumers or the bitter aftertaste of the high protein beverage may be difficult or impossible to mask to a satisfactory extent for some applications.

Whey protein contains all of the essential amino acids, and therefore, is a high quality, complete source of protein, where complete means that whey protein contains all the essential amino acids for growth of body tissues. Since whey protein is available in forms containing little fat and carbohydrates, it may be a particularly valuable source of nutrition for athletes and for individuals with special medical needs (e.g., lactose intolerant individuals), and may be a valuable component of a diet program. Further, since whey protein may contain biologically active proteins such as the immunoglobulins, lactoperoxidase, and lactoferrin, whey protein may provide advantages over other protein sources such as soy protein.

Milk and dairy based products may provide an excellent environment for the growth and propagation of a wide spectrum of microorganisms. Pasteurization, by the application of heat for a specific time, has been the traditional method used for more than 100 years to prevent or reduce the growth of microorganisms and to increase the shelf life of milk and dairy based products. Pasteurization may not kill all microorganisms in milk and dairy products. However, it does reduce their numbers so they are unlikely to cause illness in the people consuming those products. Non-sterile dairy products, including pasteurized dairy products, typically have a shelf life that is limited to a short period of time such as a few weeks due to spoilage from the growth of microorganisms which survived pasteurization or were introduced by post-processing microbial contamination.

The traditional method of pasteurization was vat pasteurization, which involved heating the liquid ingredients in a large vat or tank for at least 30 minutes. Variations on the traditional pasteurization methods have been developed, such as, high temperature short time (HTST) pasteurization, ultra pasteurization (UP) processing, and ultra high temperature (UHT) pasteurization. These variations on the traditional pasteurization method use higher temperatures for shorter times, and may result in increased shelf lives which may exceed 3 months without refrigeration. However, regardless of the pasteurization method used, stabilizers and preservatives may often be needed to improve the stability of pasteurized products.

Thermal processing by any pasteurization method may have detrimental effects on the organoleptic and nutritional properties of milk and dairy based products. Thus, there may be a need for more non-thermal methods of extending shelf life, which will not significantly decrease or alter the organoleptic and nutritional properties of milk and dairy based products.

One alternative to pasteurization may be high pressure processing (HPP), which may be especially suited to high acid content foods. HPP is a food processing method where food products may be exposed to elevated pressures, in the presence or absence of heat, to inactivate microorganisms. HPP may also be known as high hydrostatic pressure processing (HPP) and ultra high-pressure processing (UHP).

Non-thermal HPP may be used to extend the shelf life of milk and dairy based products without detrimentally altering the organoleptic and nutritional properties of these products. Non-thermal HPP may eliminate thermal degradation, and may allow for the preservation of ‘fresh’ characteristics of foods. Shelf lives similar to those of pasteurized products may be achieved from HPP.

HPP of a milk or dairy based product may be achieved by placing the product in a container within a water (or other pressure-transmitting fluid) filled pressure vessel, closing the vessel, and increasing the pressure exerted upon the container by pumping more water into the pressure vessel by way of an external pressure intensifier. The elevated pressure may be held for a specific period of time, then it may be decreased. Pressure levels of about 600 MPa at 25° C. may typically be enough to inactivate vegetative forms of microorganisms, such as non-spore forming pathogens, vegetative bacteria, yeast and molds.

HPP is explained in more detail in U.S. Pat. No. 6,635,223 B2 to Maerz, issued Oct. 21, 2003, entitled “Method for inactivating microorganisms using high pressure processing”, wherein a method for inactivating microorganisms in a product using high pressure processing is disclosed. The method involves the steps of packing the product in a flexible container, heating the product to a pre-pressurized temperature, subjecting the product to a pressure at a pressurized temperature for a time period; and reducing the pressure after that time period. The method may also further comprise an additional step of subjecting the product to a predetermined amount of oxygen for a time interval. These methods may be applied to food, cosmetic or pharmaceutical products.

Carbon dioxide (CO₂), a naturally occurring component of raw milk that decreases as raw milk is exposed to air or is pasteurized, is known to have antimicrobial properties. CO₂ results in minimal harm in foods. Therefore, it is a suitable agent for inhibiting food spoilage microorganisms. Currently, there are at least three general mechanisms known by which CO₂ inhibits microorganisms. These mechanisms, outlined briefly below, are discussed in more detail in an article by J. H. Hotchkiss et al., in Comprehensive Reviews in Food Science and Food Safety 2006; 5: 158-168, titled: “Addition of carbon dioxide to dairy products to improve quality: a comprehensive review”.

One mechanism by which CO₂ may inhibit microbial growth may simply be by the displacement of O₂ by CO₂. Another mechanism by which CO₂ may inhibit microbial growth may be by lowering the pH of the food by the dissolution of CO₂ and formation of carbonic acid in the aqueous phase of the food by the following equilibrium reactions: H₂O+CO₂ [symbol] H₂CO₃ [symbol] H⁺+HCO₃⁻ [symbol] 2H⁺+CO₃²⁻. The third mechanism by which CO₂ may inhibit microbial growth is by a direct effect of CO₂ on the metabolism of microorganisms.

The last mentioned mechanism, the direct antimicrobial effect of CO₂ on the metabolism of microorganisms, may be the result of changes in membrane fluidity due to CO₂ dissolution, reductions in intracellular pH, and direct inhibition of metabolic pathways, including decarboxylation reactions and DNA replication. CO₂ is quite lipophilic, which may allow for it to concentrate within the lipid membrane of bacteria, or to pass through the lipid membrane and to concentrate within the bacterial cell lowering intracellular pH. CO₂ may also interfere directly with required enzymatic processes within microorganisms, such as gene expression.

Published European patent application. EP 0812544 A2 of Henzler et al., published Dec. 17, 1997, entitled “Method for preparing dairy products having increased shelf-life”, describes a method for preparing dairy products having increased shelf-life by incorporating CO₂ into such products, comprising contacting a fluid milk fraction of a dairy foodstuff with CO₂, mixing the fluid milk fraction and CO₂ into a solution, and subjecting the solution to conditions sufficient to reach a steady state between the fluid milk fraction and dissolved CO₂. The patented method is said to be adapted for consumer dairy products of a wide variety, increasing shelf-life to about 45 to about 60 days.

The interaction between HPP and CO₂ and their effects on food spoilage enzymes and microorganisms were described by Corwin and Shellhammer in Journal of Food Science 2002; 67: 697-701, entitled “Combined carbon dioxide and high pressure inactivation of pectin methylesterase, polyphenol oxidase, Lactobacillus plantarum and Escherichia coli.” The enzymes studied were pectin methylesterase (PME) and polyphenol oxidase (PPO) and the microorganisms studied were Lactobacillus plantarum ATCC 8014 (L. plantarum), an acid tolerant, lactic acid producing, non-spore forming, Gram positive bacterium, and Escherichia coli K12 (E. coli), an acid sensitive, non-spore forming, Gram negative bacterium. The objective of the study was to determine the effect of CO₂ on increasing the efficacy of pressure processing to inactivate enzymes and microorganisms. CO₂ was added at approximately 0.2 molar % to solutions processed at 500 to 800 MPa in order to further inactivate PME, PPO, L. plantarum, and E. coli. A significant interaction was found between CO₂ and pressure at 25° C. and 50° C. for PME and PPO, respectively. Activity of PPO was said to be decreased by CO₂ at all pressure treatments. Survival of L. plantarum was said to be decreased by the addition of CO₂ at all pressures and the combination of CO₂ and high pressure had a significant interaction. CO₂ was said not to have a significant effect on the survival of E. coli under pressure.

U.S. Pat. No. 7,041,327 B2 to Hotchkiss et al., issued May 9, 2006, entitled “Carbon dioxide as an aid in pasteurization”, describes processes to inhibit or reduce the growth of bacteria and other pathogens in a liquid by adding CO₂ to the liquid, and thermally inactivating the bacteria and other pathogens, so that the CO₂ enhances the thermal inactivation process. The process is said to be applicable to a wide variety of fluids, liquids, semi-solids and solids. Prior to or simultaneously with thermal inactivation CO₂ is added to the product by sparging or bubbling, preferably to obtain levels of about 400-2000 ppm. At this level of CO₂, the amount of microbial death that occurs during heating in a normal pasteurization (HTST) process is said to be increased by 10% to 90% over thermal inactivation carried out without the addition of CO₂ prior to the thermal inactivation step. After completion of the thermal inactivation process, the free CO₂ is said to be removed.

Protein precipitation and separation out of proteins in protein beverages during manufacturing, shipping, and storage, may be compounded when the beverage contains an additional component, such as juice. Methods are known in the art for attempting to overcome the precipitation of protein from juice beverages. However, most of these methods involve the use of stabilizers.

Fiber or other carbohydrates may be added as a protein stabilizing agent, such as pectin, cellulose gum, xanthan gum, gum arabic, carageenan, guar gum, dextrin, dextrose monohydrate, and polydextrose. While stabilizers can help prevent protein precipitation, they may have the disadvantage of increasing the viscosity of the drink due to cross-linking with naturally present calcium cations. This increased viscosity may be undesirable as it may lead to a beverage having poor organoleptic properties for at least some applications. The range of amount of stabilizer which may be used may be quite narrow. For example, at a pectin concentration of below 0.06% by weight, sedimentation may be a significant problem, whereas above it, the viscosity of the beverage may be undesirably high. The ideal amount of stabilizer must be experimentally determined for each beverage formula, and may need to be adjusted from one batch to the next. Thus, a beverage formula which does not include a protein stabilizer but generates a beverage with good protein solubility is desirable for many applications.

U.S. Pat. No. 7,101,585 B2, to Shen et al., issued Sept. 5, 2006, entitled: “Ultra High Pressure Homogenization Process for Making a Stable Protein Based Acid Beverage” describes a process for preparing a stable suspension of an acid beverage, wherein a hydrated protein stabilizing agent (A) and a flavoring material (B) are combined as a preblend (I) and combined with either a slurry of a homogenized protein material (C) or a homogenized preblend (II) of a hydrated protein stabilizing agent (A) and a slurry of a protein material (C) to form a blend and pasteurizing and homogenizing the blend. The homogenization of the blend is carried out in two stages comprising a high pressure stage of from 8000-30,000 pounds per square inch and a low pressure stage of from 300-1,000 pounds per square inch. The acid beverage composition has a pH of from 3.0 to 4.5. This beverage contains juice, but is not carbonated. Pectin is added as a stabilizer.

Published Patent Application US 2003/0099753 A1 of Yang, published May 29, 2003, describes a fruit juice based beverage composition containing a protein selected from the group consisting of whey protein isolate and a combination of whey protein isolate and whey protein hydrolysate; a carbohydrate selected from the group consisting of sucrose, fructose, high fructose corn syrup 42 (HFCS 42), HFCS 55, combination of sucrose, fructose, HFCS 42, and HFCS 55, and combinations of maltodextrin with another carbohydrate selected from the group consisting of sucrose, fructose, HFCS 42, and HFCS 55; an edible acid selected from the group consisting of citric acid, phosphoric acid, combinations of citric acid and phosphoric acid, and combinations of malic acid with another edible acid selected from the group consisting of citric acid and phosphoric acid; a fruit juice or combinations of fruit juices; various vitamins and minerals; and optional fibers and flavors and a process for making such composition. The composition containing the above ingredients are asserted to be clear, have a pH of about 4.0 or less, and have a viscosity of less than about 40 centipoises. Protein stabilizing agents are used, including pectin.

U.S. Pat. No. 4,478,858 to Dahlen et al., issued Oct. 23, 1984, entitled: “Protein containing fruit drink and process for the manufacture thereof”, discloses a protein containing fruit juice drink comprising a fruit juice portion of 10-85% containing a citrus juice portion, a milk raw material portion of 90-15% by weight in which the milk raw material portion comprises whey proteins in an amount of 0.5-10% by weight of the finished product, and, as a sweetener, a hydrolyzed lactose, made of substantially pure lactose prepared from whey or a permeate from ultrafiltration of milk or whey, containing pure glucose and galactose derivative, which is alleged to act as a binder of the protein even in fruit drinks containing a citrus juice portion. The fruit drink may be manufactured in a concentrated form from a protein concentrate, concentrated fruit juice and/or fruit aromas and a concentrated hydrolysed lactose. A polysaccharide containing stabilizer may be added to the concentrate.

### DETAILED DESCRIPTION OF CERTAIN EMBODIMENTS

As a preface to the detailed description, it should be noted that, as used in this specification and the appended claims, the singular forms “a”, “an”, and “the” include plural referents, unless the context clearly dictates otherwise.

The terms “about” and “approximately” as used herein, indicate that the precision of the nominal value presented is ±10%.

The protein beverage composition of the disclosed embodiments of the present invention, produced using the method described below, provides a high protein content (relative to previously described drinks). In addition, while the protein drink may be heat treated to inactivate microbes, the final product exhibits storage shelf-stability which is unexpectedly long for such a product.

We have developed an improved protein beverage/drink, which contains a high protein concentration compared with protein concentrations of drinks previously known in the industry. The typical concentration of protein ranges from about 0.01% by weight to about 15% by weight, more typically the protein concentration ranges from about 2% by weight to about 15% by weight, with the most typical concentration ranging from about 2% by weight to about 5% by weight.

In certain embodiments, a protein beverage composition suitable for human consumption, comprising: protein essentially free of caseinate and derived from an aqueous protein isolate, which has been collected from membrane-filtration isolation of the protein and has never been dried; and, wherein said protein beverage composition exhibits a pH ranging from about 2.0 to about 4.6, whereby substantial solubility of the protein is maintained in the beverage composition, and wherein said protein beverage is essentially free of active microbes known to be harmful to human health, both at the time of packaging of the protein beverage and for a time period of at least 18 months after packaging. Typically, the protein beverage composition may contain about 0.01% by weight to about 15% by weight protein and a balance of water. More typically, the protein beverage composition may contain about 0.01% by weight to about 8% by weight protein and a balance of water. Most typically, the protein beverage composition may contain about 2% by weight to about 8% by weight protein and a balance of water.

In other embodiments, a method of preparing a protein beverage, comprising: admixing an aqueous protein isolate, which has been collected from membrane-filtration isolation of the protein and has never been dried, with a pH adjusting agent to provide a pH of between about 2 and about 4.6, thereby obtaining an admixture. Typically, the protein beverage may contain about 0.01% by weight to about 15% by weight protein and a balance of water. More typically, the protein beverage may contain about 0.01% by weight to about 8% by weight protein and a balance of water. Most typically, the protein beverage composition may contain about 2% by weight to about 8% by weight protein and a balance of water.

In one embodiment, the protein is essentially free from caseinate. Typically, the essentially caseinate free protein is whey protein, of the kind previously described herein. In some embodiments, the essentially caseinate free protein may have some caseinate or may be a whey protein which may be derived from whey protein isolate or whey protein concentrate, although other whey protein preparations may be used, such as, for example, but not by way of limitation, a whey protein extract or a whey protein hydrolysate. The whey protein isolate may typically be an aqueous whey protein isolate, with a whey protein concentration of about 1% by weight to about 40% by weight. The whey protein concentrate may typically be an aqueous whey protein concentrate, with a whey protein concentration of about 1% by weight to about 40% by weight. In addition, the total protein content can be increased by the addition of mixtures of proteins such as whey protein and other proteins such as soy proteins.

In certain embodiments, the protein beverage suitable for human consumption comprises: about 2% by weight to about 8% by weight protein, derived from an aqueous protein isolate, which has been collected from membrane-filtration isolation of the protein and has never been dried, and a balance of water; and, wherein said protein beverage exhibits a pH ranging from about 3.0 to about 6.0, whereby substantial solubility of the protein is maintained in the beverage composition, and wherein said protein beverage is essentially free of active microbes known to be harmful to human health, both at the time of packaging of the protein beverage and for a time period of at least 18 months after packaging. The protein beverage may optionally further contain about 0% by weight to about 1.5% by weight flavor, about 0% by weight to about 0.5% by weight sweetener, about 0% by weight to about 0.5% by weight acidulent, about 0% by weight to about 0.1% by weight color, and about 0% by weight to about 1.5% by weight dietary fiber. In one embodiment, the aqueous protein isolate may be an aqueous whey protein isolate. In another embodiment, the aqueous protein isolate may be an aqueous soy protein isolate. In further embodiments, the aqueous protein isolate may be derived from one or more of edible aqueous proteins, such as, for example, but not limited to, whey protein, soy protein, casein, lactalbumin, serum albumin, glycomacropeptide, rice protein, pea protein, canola protein, wheat protein, hemp protein, zein, flax protein, egg white protein, ovalbumin, gelatin protein, or a combination thereof.

In certain embodiments, the protein beverage suitable for human consumption may be a flavored water beverage containing protein, which is comprised of about 2% by weight to about 8% by weight protein, derived from an aqueous protein isolate, which has been collected from membrane-filtration isolation of the protein and has never been dried, and a balance of water; and, wherein said protein beverage exhibits a pH ranging from about 3.0 to about 6.0, whereby substantial solubility of the protein is maintained in the beverage composition, and wherein said protein beverage is essentially free of active microbes known to be harmful to human health, both at the time of packaging of the protein beverage and for a time period of at least 18 months after packaging. The protein beverage may optionally further contain about 0% by weight to about 1.5% by weight flavor, about 0% by weight to about 0.5% by weight sweetener, about 0% by weight to about 0.5% by weight acidulent, about 0% by weight to about 0.1% by weight color, and about 0% by weight to about 1.5% by weight dietary fiber. In one embodiment, the aqueous protein isolate may be an aqueous whey protein isolate. In another embodiment, the aqueous protein isolate may be an aqueous soy protein isolate. In further embodiments, the aqueous protein isolate may be derived from one or more of edible aqueous proteins, such as, for example, but not limited to, whey protein, soy protein, casein, lactalbumin, serum albumin, glycomacropeptide, rice protein, pea protein, canola protein, wheat protein, hemp protein, zein, flax protein, egg white protein, ovalbumin, gelatin protein, or a combination thereof.

Whey protein is a protein fraction obtained from mammalian milk. Commercially available whey protein is typically derived from the milk of cows; however, whey protein may be derived from the milk of any mammal, such as, for example, but not by way of limitation, the milk of goats, sheep, buffalo, camel, black bear, llama, deer, kangaroo, pig, dog, rabbit, elephant, dolphin, donkey, horse, seal, or human. Alternatively, whey protein may be prepared by recombinant DNA technology, using molecular biology techniques commonly known in the art.

In other embodiments, the protein may be any edible protein, other than whey protein, such as, for example, but not by way of limitation, casein, lactalbumin, serum albumin, glycomacropeptide, soy protein, rice protein, pea protein, canola protein, wheat protein, hemp protein, zein, flax protein, egg white protein, ovalbumin, gelatin protein, or any combination thereof.

In another embodiment, the protein may be a combination of a whey protein, of the kind previously described herein, and an edible protein, other than whey protein, such as, for example, but not by way of limitation, casein, lactalbumin, serum albumin, glycomacropeptide, soy protein, rice protein, pea protein, canola protein, wheat protein, hemp protein, zein, flax protein, egg white protein, ovalbumin, or gelatin protein.

In one embodiment the protein may be an aqueous soy protein isolate, with a soy protein concentration of about 1% by weight to about 20% by weight. However, other aqueous protein isolates may be used.

Whey protein isolate may be obtained by removing sufficient non-protein constituents from whey by membrane filtration or ion exchange absorption, so that the finished dry product may contain about 90% by weight or more whey protein, and little, if any, fat, cholesterol, or carbohydrates (e.g., lactose). Prior to concentration and spray drying, aqueous whey protein isolate (WPIaq) may have a whey protein concentration of about 1% by weight to about 35% by weight, and may also be essentially free of fat, cholesterol, and carbohydrates.

Aqueous whey protein isolate (WPIaq) may be collected at a concentration by weight of about 20% to about 35% actual whey protein.

WPIaq may be diluted with water to a protein concentration of about 1% to about 24%, representing a range from single-strength beverage protein level to a concentrate suitable for acidification, nutrient addition, transport to a beverage manufacturing facility and subsequent dilution, thermal processing, and containerization.

The distinct advantages of utilizing the aqueous protein stream from membrane filtration may include the absence of damage due to intense shear forces, heat, and dehydration which are inherent to traditional spray-dried protein powder ingredients. Additionally, there may be substantially lower microbial population, especially of yeasts, molds, and related spores which may be introduced into the ingredient during drying. Manufacturing economies are also afforded by obviating the need for spray drying the protein at the protein manufacturer and the re-hydration of protein powders as part of the beverage manufacturing process; time and labor savings as well as reduced protein foam interference may be among the benefits.

If not clouded by added ingredients, the flavor, odor, and clarity or transparency of the finished beverage may be generally superior to a beverage of identical nutrient composition which is produced using powdered whey protein isolate.

While not wishing to be bound by any present theory of action, it is presently believed that lowering the pH of the aqueous whey protein prior to addition to the beverage composition results in a protein beverage with superior organoleptic properties, by preventing or at least greatly reducing precipitation and gelling of the protein as it passes through the zone of isoelectric points. It is believed that prior art drinks did not attempt to move rapidly to the final pH and permitted the composition to dwell too long at low temperatures at or near the isoelectric point, thereby permitting much or all of the material to precipitate. With the inventors' discovery that this transient state of low solubility can be traversed before precipitation commences, practitioners can easily make these clear beverages with minimal testing.

Whey proteins have a high buffering capacity, and therefore this pH adjustment step tends to prevent the whey protein from buffering the acids of the beverage.

The typical concentration of juice in the finished beverage ranges from about 0% by weight to about 100% by weight, more typically the juice concentration ranges from about 0% by weight to about 98% by weight, with the most typical concentration ranging from about 0% to about 25% by weight. Typically the juice source may be fruit juice, vegetable juice, or a combination thereof, and may be added in whole, as a liquid, a liquid concentrate, a puree, or in another modified form containing one or more juice components. More typically, the juice may be depectinized, having had most of the pectins removed by enzymatic digestion, chromatography, precipitation, or by another method of juice depectinization. One method by which the juice may be depectinized is by treating it with pectinase enzyme, as described in detail in U.S. Pat. No. 6,620,452 B1. A depectinized juice may typically be a juice with a pectin content of about 0.05 weight % to about 0.25 weight %.

A single fruit juice, a single vegetable juice, fruit juice blends, vegetable juice blends, or fruit and vegetable juice blends may be used. Examples of a few of the many specific juices which may be used may include juice from alfalfa sprouts, apples, apricots, avocados, bamboo shoots, bananas, beans, bean sprouts, beets, berries of all types, cabbage, carrots, celery, cherries, cucumbers, currants, dates, figs, grapefruits, grapes, guava, kiwi, kumquat, lemons, limes, lychee fruit, mandarin, mango, melons of all types, nectarines, noni, oranges, papaya, passion fruit, peaches, pears, pineapples, plums, pomegranates, prunes, radishes, rhubarbs, rutabagas, seaweed, squash, tangelo, tangerines, tomatoes, and/or turnips; however, any type of juice may be used.

In some embodiments the protein beverage may be carbonated. The amount of carbonation which has been achieved while maintaining stability of the carbonated drink is unexpectedly high in view of the amount of protein present, with the amount of carbonation ranging from about 0.1 volumes of carbonation (per volume of liquid present in the beverage) to about 6 volumes of carbonation. More typically, the amount of carbonation present ranges from about 1.6 volumes to about 3.5 volumes, with the most typical concentration ranging from about 1.7 volumes to about 3.0 volumes.

Additives may be combined with the basic high protein beverage formulation to provide a “high energy” high protein beverage. For example, caffeine may be added to increase the level of circulating fatty acids in the body of a consumer of the beverage. This increase in circulation has been shown to increase the oxidation of these fuels, enhancing fat oxidation in general. Caffeine is well known as a means of enhancing fatty acid metabolism.

Another additive which may be included is magnesium. Magnesium may affect energy level and may be needed for more than about 300 biochemical reactions in the body. Magnesium may help regulate blood sugar levels, may promote normal blood pressure, and may support energy metabolism and protein synthesis.

A third additive may be added to affect energy level. The third additive may be citrulline malate. Citrulline is an amino acid which may play a role in nitrogen balance and metabolic processes. Supplemental citrulline malate is a salt form of the amino acid. Citrulline malate may improve aerobic performance and capacity by influencing lactic acid metabolism and reducing fatigue.

One or more of these effects on metabolism have been supported by evidence of an increase in the rate of oxidative adenosine triphosphate (ATP), which is essentially a “molecular currency” of intracellular energy transfer, and an increase in energy production during the exercise of muscles. These three additives which assist in the generation of energy, and combinations thereof, have been formulated into the high protein beverages described herein with little or no adverse effect on manufacturability or shelf storage life of the product.

The citrulline malate energy generating additive may have a very bitter taste in free form. We were surprised to discover that citrulline malate employed in a protein beverage of the kind described herein, provides a pleasant tasting beverage without the need to make a major modification from the recipes which do not contain the citrulline malate.

In addition to the high protein concentration, the protein beverage is essentially free from biologically pathogenic microbes such as bacteria and other spoilage pathogens of the kind which are monitored by the food industry in general. Due to the method used to inactivate the biologically pathogenic microbes, the protein beverage is essentially free from these pathogenic microbes for more than 18 months after packaging of the protein beverage into individual containers or servings and storage under shelf conditions which are standard in the unrefrigerated beverage industry. In addition to absence of biologically pathogenic microbes, there is little or no precipitation of protein, little or no thickening, flavor and color are maintained, and taste and mouth feel are maintained. In formulations which are designed to be transparent, without turbidity, the protein beverage is clear in color after this storage period. The recommended storage temperature is above freezing (32° F.) to about 75° F. Storage of the protein beverage at temperatures in excess of 100° F. for time periods of several months, such as about five months, are even possible without detriment to the taste and clarity.

In one embodiment, the protein drink may be treated to inactivate microbes in the presence of carbonation which may be used to provide taste and mouth feel for the drink, while maintaining the required minimal amount of carbonation to provide such taste and mouth feel.

The treatment to inactivate or remove microbes may include thermal processing by exposure to elevated temperature, aseptic packaging, carbonation, ozonation, radiation, ultra violet light, high pressure processing, filtration, membrane permeation, pulsed electric field, sonication, and combinations thereof. Typically, the treatment for microbe inactivation may be carried out in the individual serving package used for storage and handling of the carbonated protein drink. Testing has shown that for microbe inactivation carried out in the individual serving package, plate count for microbes is negligible and typically zero after a storage period of more than 18 months at temperatures ranging between 35° F. and about 75° F.

In one embodiment, thermal processing is not used to inactivate microbes. In this embodiment the microbial inactivation is due to the addition of carbon dioxide to the protein drink. As previously described, the CO₂ may inhibit microbial growth by the displacement of O₂ by CO₂, by lowering the pH of the carbonated protein beverage by the dissolution of CO₂ and formation of carbonic acid, and by a direct effect of CO₂ on the metabolism of microorganisms.

In another embodiment, thermal processing is not used to inactivate microbes. In this embodiment the microbial inactivation is due to high pressure processing (HPP) of the protein drink. The HPP may be applied to the protein drink prior to carbonation and packaging, after carbonation and prior to packaging, or after carbonation and packaging. The HPP may also be used for a protein drink that is not carbonated. Various types of HPP equipment systems may be used, such as those produced by Avure Technologies of 22408 66^{th} Avenue South, Kent, Wash. 98032, Elmhurst Research, Inc. of 60 Loudonville Rd., Albany, N.Y. 12204, and NC Hyperbaric of 28760 Tres Cantos, Madrid, Spain.

The HPP may be achieved by placing the protein beverage in a container within a water (or other pressure-transmitting fluid) filled pressure vessel, closing the vessel, and increasing the pressure exerted upon the container by pumping more water into the pressure vessel by way of an external pressure intensifier. The elevated pressure may be held for a specific period of time, then it may be decreased. Pressure levels of about 600 MPa at 25° C. may typically be enough to inactivate vegetative forms of microorganisms, such as non-spore forming pathogens, vegetative bacteria, yeast and molds. The HPP may be carried out by the method described in U.S. Pat. No. 6,635,223 B2 to Maerz, issued Oct. 21, 2003, entitled “Method for inactivating microorganisms using high pressure processing”.

In another embodiment, thermal processing is not used to inactivate microbes. In this embodiment the microbial inactivation is due to the combined effects of the addition of carbon dioxide to the protein drink and HPP of the carbonated protein drink. The HPP may be applied to the carbonated protein drink prior to packaging or after packaging.

In other embodiments, thermal processing is not used to inactivate microbes. In these embodiments the microbial inactivation may be due to carbonation, aseptic packaging, ozonation, radiation, ultra violet light, HPP, membrane permeation, pulsed electric field, sonication, combinations thereof and others.

In yet another embodiment of the invention, thermal processing is used to inactivate microbes. The bulk beverage is pasteurized in a manner common to the beverage and fruit juice industries known as “hot-fill”, where product is thermally processed in a continuous flow with a maximum temperature of about 160° F. to about 200° F. with a holding time at that maximum temperature ranging from about 15 seconds to about 3 seconds. Product is cooled slightly to about 160° F. to about 185° F. just prior to being filled into glass or plastic containers designed for hot-fill.

Continuous process method has several advantages over the vat method, the most important being time and energy saving. For most continuous processing, a high temperature short time (HTST) pasteurizer is used. The heat treatment is accomplished using a plate heat exchanger. This piece of equipment consists of a stack of corrugated stainless steel plates clamped together in a frame. There are several flow patterns that can be used. Gaskets are used to define the boundaries of the channels and to prevent leakage. The heating medium can be vacuum steam or hot water.

A protein beverage of an embodiment of the invention may further contain additional additives to: enhance the nutritional value (other than those particularly added for energy generation enhancement); aid in protection of the muscular system and joints during physical activity; add to the flavor value of the beverage; or, to provide a desired appearance of the beverage, provided that the additional agent is stable in the beverage. In an embodiment of the invention the protein beverage may be consumed as a meal replacement. Examples of additional agents which enhance nutritional value include nutrients such as vitamins, minerals (including calcium or a calcium derivative), herbal supplements, concentrated plant extracts, glucosamine, amino acids, fatty acids, and fiber. The examples include the following: vitamins such as vitamin A, vitamin C, vitamin D, and vitamin E, by way of example and not by way of limitation; minerals such as zinc, chromium, iron, calcium, magnesium (previously mentioned), and potassium, by way of example and not by way of limitation; herbal supplements such as ginseng, gingko biloba, saw palmetto, green tea, and hoodia gordonii, by way of example and not by way of limitation; amino acids, such as L-Glutamine, L-Arginine, Taurine, creatine, N-acetyl-cystine, N-acetyl-carnitine, L-Leucine, L-isoleucine and L-valine, by way of example and not by way of limitation; fatty acids such as docosahexaenonic acid (DHA), eicosapentaeonic acid (EPA), Omega 3's and Omega 6's, by way of example and not by way of limitation; and fiber such as oligofructopolysaccharides, corn fiber, oat fiber, and flax fiber, by way of example and not by way of limitation.

Concentrated plant extracts, which may be high in vitamins and nutrients, while low in calories, may be added. These extracts may be derived from fruits, herbs, vegetables, and other plants which may have high content of nutritional components. Production of the extracts may be carried out by conventional methods, such as those described in detail in U.S. Pat. No. 6,620,452 B1; however, these extracts may be commercially available. One example of these extracts may be the extract derived from green tea, called Sunphenon 90M, from Taiyo International, Minneapolis, Minn. 55416, USA.

An example of an additive to aid in protection of the muscular system and joints during physical activity may be a hyperimmune milk protein concentrate which works in combination with the edible nutritional protein already present in the protein beverage. The hyperimmune milk protein concentrate may be manufactured in the manner described in detail in U.S. Pat. No. 5,650,175. One example of the hyperimmune milk protein is available from Stolle Milk Biologics of Chicago, Ill. under the trade name MicroLactin™ and distributed by Humanetics Corporation of Eden Prairie, Minn., by way of example and not by way of limitation. The hyperimmune milk protein concentrate may be derived from whey, such as a fractionization from whey. However, the hyperimmune milk protein concentrate may exhibit functional properties similar to casein. Use of a hyperimmune milk protein concentrate in the beverage formulation typically results in a beverage which exhibits turbidity.

The flavoring agent or agents may provide a fruit flavor, cola flavor, vanilla flavor, or a chocolate flavor, by way of example and not by way of limitation. Other flavorings, such as, by way of example, and not by way of limitation, Stevia leaf extract and Lo Han Guo. Sweeteners, natural or synthetic, such as sucrose, sucralose, aspartame, and/or acesulfame potassium, neotame, polydextrose, glycerin, sorbitol, high fructose corn syrup, corn syrup, saccharin, honey, molasses, maple syrup, and xylitol, may be used, by way of example and not by way of limitation. Coloring agents may be added. Agents such as citric acid, fumaric acid, adipic acid, tartaric acid, and in some instances lactic acid may be added to adjust for tartness.

Additional ingredients in the form of analgesics, such, for example, as aspirin may be added in specialized product applications. Mild stimulants other than the foregoing mentioned caffeine, such, for example, as green tea may be added. Relaxants, such, for example, as melatonin may also be added.

To provide stability, the protein drink may include an antifoaming agent such as dimethylpolysiloxane, and a pH adjusting agent such as phosphoric acid, citric acid, tartaric acid, fumaric acid, adipic acid, and in some instances lactic acid. Excess citric acid and malic acid can cause tartness and astringency of taste and produce an unpalatable beverage that has an unacceptable mouth-feel when consumed. Phosphoric acid is presently preferred as a pH adjusting agent, as the quantity required to obtain a desired pH may be typically less, and the taste of the beverage may be less affected by the pH adjustment. The adjusted pH of the protein drink typically ranges from about 2.0 to about 5.5, more typically from about 2.0 to about 3.4. To further provide stability, the protein drink may be formulated to essentially exclude a component which includes caseinate. Caseinate may not be stable at the pH of the protein beverage.

One or more preservatives may be added to the protein beverage, such as, for example, one or more chemical preservatives, one or more natural preservatives, a combination thereof, or others. Examples of chemical preservatives which may be used include, for example, a sorbate or a benzoate. Examples of natural preservatives which may be used include, for example, nisin or natamycin, which may be obtained commercially from a food ingredient supplier, such as Danisco A/S Langebrogade 1 DK-1001 Copenhagen.

The protein drink may be prepared by admixing in water, an anti-foaming agent, an amount of a pH adjusting agent to provide a pH of about 2 to about 5.5 and an amount of protein sufficient to provide a final protein content in the beverage ranging from about 0.01% by weight to about 8% by weight protein.

The protein drink may be carbonated by adding carbon dioxide to the admixture in an amount sufficient to obtain a carbonated protein beverage where the amount of carbonation present in the beverage ranges from about 0.1 volumes to about 6 volumes per volume of liquid admixture. In some embodiments of the method, the carbon dioxide may be added in the form of sterile carbonated water. In other embodiments, sterile carbon dioxide is bubbled through the liquid admixture until the desired amount of carbon dioxide is present. In either embodiment, the final protein content of the beverage ranges from about 0.01% by weight to about 8% by weight, and the carbonation ranges from about 0.1 volumes to about 6 volumes. In other embodiments, the final protein content of the beverage ranges from about 2% by weight to about 8% by weight and the carbonation ranges from about 0.1 volumes to about 6 volumes.

The protein drink may be prepared by admixing in water, an anti-foaming agent, an amount of a pH adjusting agent to provide a pH of about 2 to about 4.6, an amount of juice to provide a final juice content in the beverage ranging from about 0% by weight to about 100% by weight juice, and an amount of protein sufficient to provide a final protein content in the beverage ranging from about 0.01% by weight to about 8% by weight protein; heating the admixture to a temperature ranging from about 140° F. to about 188° F. for a time period adequate to inactivate microbes which may be present in the admixture; cooling the admixture to a temperature of about 40° F. or less.

The protein beverage may be carbonated by adding carbon dioxide to the admixture in an amount sufficient to obtain a carbonated protein beverage where the amount of carbonation present in the beverage ranges from about 0.1 volumes to about 6 volumes per volume of liquid admixture. In some embodiments of the method, the carbon dioxide is added in the form of sterile carbonated water. In other embodiments, sterile carbon dioxide is bubbled through the liquid admixture until the desired amount of carbon dioxide is present. In either embodiment, the final juice content of the beverage ranges from about 0% by weight to about 100% by weight, the final protein content of the beverage ranges from about 0.01% by weight to about 8% by weight, and the carbonation ranges from about 0.1 volumes to about 6 volumes. In other embodiments, the final juice content of the beverage ranges from about 0% by weight to about 98% by weight, the final protein content of the beverage ranges from about 2% by weight to about 8% by weight, and the carbonation ranges from about 0.1 volumes to about 6 volumes.

The protein drink may also be prepared in a manner similar to that described above, with the additional step of HPP to inactivate microbes in the protein beverage. The HPP step may take place prior to the addition of carbon dioxide or after the addition of carbon dioxide. The carbonated protein beverage may be treated with HPP prior to packaging or after packaging in containers.

The protein drink may also be prepared in a manner similar to that described above, with the exception that the heating of the admixture may be carried out after addition of the carbonation rather than prior to addition of the carbonation. This requires that provisions be made to maintain the carbonation during the heating and cooling process. We have discovered that it is possible to maintain the carbonation if the carbonated protein beverage may be packaged in individual size containers and the containers of beverage may then be processed for microbe inactivation.

In another embodiment, the protein drink may include about 0% alcohol by volume to about 15% alcohol by volume. Typically, the percent alcohol by volume ranges from about 4% by volume to about 8% by volume. The alcohol used may be derived from malt based, fermented from grain.

In other embodiments, the protein drink may be prepared in concentrated forms, which may be diluted prior to consumption with a liquid, such as, for example, but not by way of limitation, water, fruit juice, vegetable juice, tea, alcohol, coffee, milk, soy milk, rice milk, almond milk, a combination thereof, or others. Certain embodiments include a liquid used for dilution, which may be a carbonated liquid or a still liquid. If a still liquid is used, the beverage may be carbonated with carbon dioxide gas after dilution.

An embodiment of a protein beverage concentrate may be a concentrated syrup, which may include about 0% by weight to about 60% by weight of juice concentrate, wherein said juice concentrate has a Brix value of about 20° Brix to about 75° Brix, and about 0.02% by weight to about 75% by weight protein. Another embodiment of a protein beverage concentrated syrup may include about 0% by weight to about 60% by weight of juice concentrate, wherein said juice concentrate has a Brix value of about 20° Brix to about 75° Brix, and about 4% by weight to about 75% by weight protein. Such protein beverage concentrated syrup may, at the time of packaging and during subsequent storage without refrigeration, maintain substantial solubility of the protein. Such embodiment of the protein beverage concentrated syrup may also, at the time of packaging and during subsequent storage, be essentially free of pathogenic microbes known to be harmful to human health.

The protein beverage concentrated syrup may include about 0% by weight of juice concentrate and about 0.02% by weight to about 40% by weight protein.

The juice concentrate used for the protein beverage concentrated syrup may be derived from a single fruit juice, a single vegetable juice, fruit juice blends, vegetable juice blends, or fruit and vegetable juice blends may be used. Examples of a few of the many specific juices which may be used may include, but are not limited to, juice from alfalfa sprouts, apples, apricots, avocados, bamboo shoots, bananas, beans, bean sprouts, beets, berries of all types, cabbage, carrots, celery, cherries, cucumbers, currants, dates, figs, grapefruits, grapes, guava, kiwi, kumquat, lemons, limes, lychee fruit, mandarin, mango, melons of all types, nectarines, noni, oranges, papaya, passion fruit, peaches, pears, pineapples, plums, pomegranates, prunes, radishes, rhubarbs, rutabagas, seaweed, squash, tangelo, tangerines, tomatoes, and/or turnips, as well as combinations thereof, however, any type of juice may be used.

The protein used for the protein beverage concentrated syrup embodiment may be essentially free from caseinate. In some embodiments, the essentially caseinate free protein may have some caseinate or may be a whey protein, of the kind previously described herein. An essentially caseinate free protein may be a whey protein which may be derived from whey protein isolate or whey protein concentrate, although other whey protein preparations may also be used, such as, for example, but not by way of limitation, a whey protein extract or a whey protein hydrolysate. The whey protein isolate may be an aqueous whey protein isolate, with a whey protein concentration of about 1% by weight to about 40% by weight. The whey protein concentrate may be an aqueous whey protein concentrate.

Whey protein isolate may be obtained by removing sufficient non-protein constituents from whey by membrane filtration or ion exchange absorption, so that the finished dry product may contain about 90% by weight or more whey protein, and little, if any, fat, cholesterol, or carbohydrates (e.g., lactose). Prior to concentration and spray drying, aqueous whey protein isolate (WPIaq) may have a whey protein concentration of about 1% by weight to about 35% by weight, and may also be essentially free of fat, cholesterol, and carbohydrates.

Aqueous whey protein isolate (WPIaq) is collected at a concentration by weight of about 20% to about 35% actual whey protein.

WPIaq is diluted with water to a protein concentration of about 1% to about 24%, representing a range from single-strength beverage protein level to a concentrate suitable for acidification, nutrient addition, transport to a beverage manufacturing facility and subsequent dilution, thermal processing, and containerization.

The protein used for the protein beverage concentrated syrup may also include any edible protein, other than whey protein, such as, for example, but not by way of limitation, casein, lactalbumin, serum albumin, glycomacropeptide, soy protein, rice protein, pea protein, canola protein, wheat protein, hemp protein, zein, flax protein, egg white protein, ovalbumin, gelatin protein, any combination thereof, or others.

The protein used for the protein beverage concentrated syrup may also include a combination of a whey protein, of the kind previously described herein, and an edible protein, other than whey protein, such as for example, but not by way of limitation, casein, lactalbumin, serum albumin, glycomacropeptide, soy protein, rice protein, pea protein, canola protein, wheat protein, hemp protein, zein, flax protein, egg white protein, ovalbumin, gelatin protein, any combination thereof, or others.

Typically the pH of the aqueous protein (isolate or concentrate) may be adjusted with an appropriate pH adjusting agent to match the pH of the beverage composition prior to mixing the protein with the beverage composition.

The protein beverage concentrated syrup may further include about 0% by weight to about 100% by weight filler, wherein the filler may be water, a sweetener, a flavoring agent, a coloring agent, an anti-foaming agent, a nutrient, calcium or a calcium derivative, an energy-generating additive, an herbal supplement, a concentrated plant extract, a preservative, combinations thereof, or others.

The protein beverage concentrated syrup may be treated to inactivate microbes by pasteurization, aseptic packaging, carbonation, ozonation, radiation, ultraviolet light, high pressure processing, membrane permeation, pulsed electric field, sonication, combinations thereof, or other microbial inactivation treatments.

The protein beverage concentrated syrup may range from about a two-fold syrup to about a twenty-five-fold syrup. A further embodiment of the protein beverage concentrated syrup may be prepared as about a five-fold syrup, wherein one part protein beverage concentrated syrup may be diluted with four parts liquid to prepare a protein beverage. The liquid may be any suitable liquid for human consumption, such as, for example, but not by way of limitation, water, fruit juice, vegetable juice, tea, alcohol, coffee, milk, soy milk, rice milk, almond milk, combinations thereof, or others.

In some embodiments the protein beverage made from the protein beverage concentrated syrup may be a carbonated beverage. The carbonation of the protein beverage may range from about 1.0 volumes to about 3.5 volumes per volume of beverage, preferably, about 1.6 to about 3.5 volumes per volumes of beverage; more preferably, about 1.6 to about 3.0 volumes per volume of beverage.

The carbonation may be added in the form of carbonated liquid, such as, for example, but not by way of limitation, carbonated water. The carbonation may be added by bubbling sterile carbon dioxide through the protein beverage until the desired amount of carbon dioxide is present. The carbonation may also be added by the addition of any edible carbonation source, such as, for example, but not by way of limitation, a carbonate material capable of reacting with an acid or mixture of acids to effect the release of carbon dioxide upon contact with water. See U.S. Patent Application Publication No. 20020136816, the disclosure of which is incorporated herein by reference.

In some embodiments the protein beverage concentrated syrup may be used by an individual, and may be packaged in single use servings or in small bottles, such as, for example, but not by way of limitation 50 ml-1500 ml bottles suitable for household use. In other embodiments the protein beverage concentrated syrup may be packaged in larger containers suitable for use in a food services beverage dispenser or in a restaurant or bar beverage dispenser. In yet other embodiments the protein beverage concentrated syrup may be produced in large batches for use in the preparation of a protein beverage at a bottling plant or other commercial beverage preparation facility.

The protein beverage concentrated syrup may be prepared by admixing a juice concentrate having a Brix value of about 20° Brix to about 75° Brix, to achieve a percent by weight of juice concentrate of about 0% by weight to about 60% by weight and a protein to achieve a percent by weight of protein in the admixture of about 0.05% by weight to about 60% by weight, thereby obtaining an admixture. The protein beverage concentrated syrup may be packaged in a container which may be stored at room temperature.

In one embodiment the protein beverage concentrate may be a concentrated powder, which may be prepared as a dry preparation, such as, for example, but not by way of limitation, a powder, granular, crystal, or other type of dry particle preparations. The dry preparations may be prepared by mixing the various ingredients as described above to form a concentrated syrup, then drying the syrup to a dry powder form by conventional drying methods, such as, for example, but not by way of limitation, lyophilization (freeze drying), spray drying, fluid bed drying, drum drying, combinations thereof, or others.

In many of the Examples described below, the protein used is whey protein, since this protein provides the taste and offers other nutritional advantages of the kind previously discussed. However, one skilled in the art will understand that by adjusting the pH to extend to higher or lower pH ranges and/or producing a carbonated protein drink having a protein content at other positions in the range of about 0.01% to about 15%, other proteins such as milk protein, soy protein, lactalbumin, serum albumin, glycomacropeptide, rice protein, pea protein, canola protein, wheat protein, hemp protein, zein, flax protein, egg white protein, ovalbumin, gelatin, combinations thereof, or others, by way of example and not by way of limitation, may also be used, alone or in combination, to create the present protein beverage. Hydrolysates and derivatives of these common protein sources may also be used in embodiments contemplated by this disclosure.

In most of the Examples described below, the method used to inactivate microbes is pasteurization, however other methods may be used, such as aseptic packaging, carbonation, ozonation, radiation, ultra violet light, high pressure processing, membrane permeation, pulsed electric field, sonication, combinations thereof, or others.

### EXAMPLES

### Example One

The following example describes use of the aqueous protein ingredient for the production of approximately 10,000 liters of a fruit-flavored protein beverage with a whey protein concentration of 3.33%, approximately equal to the total protein concentration in bovine milk. The weight of the batch is approximately 10,350 kg.

Temperature should be maintained in the range of 40-50 degrees Fahrenheit during the acidification process.

1035 kg of Aqueous Whey Protein at 33.3% (w/w) total protein is diluted by addition and slow mixing of an equal weight of purified water to yield 2070 kg of aqueous 16.65% whey protein.

Approximately 50 kg of 85% phosphoric acid is added at a rate of about 5 kg/minute with constant mixing with the endpoint being a target pH of 3.2±0.2.

Acidified aqueous protein is transferred into two bulk totes designed for palletized food-grade liquid transport. The totes typically have a capacity of 250-300 gallons, and in this case the totes contain a total of about 450 gallons.

Bulk transport should be conducted in a manner by which temperature can be maintained at 40-60 degrees.

After arrival at a beverage manufacturing facility, the protein is transferred to a batch mixing tank of appropriate volume (in this example, 3,000-5,000 gallon capacity).

Additional water is added to reach approximately 99% of finished volume, after which flavors, colors, sweeteners, and other desired ingredients are added. Final pH of 3.2±0.2 is achieved by addition of a single organic acid such as citric acid, malic acid, tartaric acid, a combination thereof, or other organic acids.

The bulk beverage is pasteurized in a manner common to the beverage and fruit juice industries known as “hot-fill”, where product is thermally processed in a continuous flow with a maximum temperature of 160-200° F. with a holding time at that maximum temperature ranging from 15 seconds to about 3 seconds. Product is cooled slightly to 160-185° F. just prior to being filled into glass or plastic containers designed for hot-fill.

### Example Two

An alternate method of producing such a beverage can be performed by the fall dilution and ingredient addition being conducted at the site of protein production, followed by bulk transport of finished beverage to the beverage processor/bottler. This method is considered to be more costly due to transport of additional water and would generally be avoided unless the beverage processor was unable to complete the batch preparation.

### Example Three

Another alternate method of producing such a beverage consists of transport of the highly concentrated aqueous protein in its undiluted and unacidified state, after which these steps are performed at the site of beverage processing and container filling.

### Example Four

A fourth example involves the use of the aqueous protein stream from membrane-filtration isolation of soy protein. In this example, addition of antimicrobial agents at the beginning of the process is recommended, as the aqueous soy protein would not be acidified either as a concentrate or as a finished beverage due to its insolubility in acid solutions. Temperature should be maintained at 30-42° F. until final beverage processing using aseptic technology for sterilization and container filling.

### Example Five

The following example describes use of the aqueous protein ingredient for the production of approximately 385 liters of a water based, fruit-flavored protein beverage with a whey protein concentration of about 3.35%, approximately equal to the total protein concentration in bovine milk. The weight of the batch is approximately 387 kg.

Temperature should be maintained in the range of 40-50 degrees Fahrenheit during the acidification process.

Approximately 3.6 kg of dietary fiber (such as VitaSugar™ brand fiber, from Bio Neutra, located in Edmonton, Canada) is diluted by addition and slow mixing into approximately 316.3 kg of purified water. Alternatively, a small amount, such as approximately 1 kg or less, of the dietary fiber may be reserved to make a “premix” with other dry ingredients that are added in small amounts of less than 1 kg.

Approximately 64.8 kg of an aqueous whey protein isolate (such as the aqueous whey protein isolate available from Trega, located in Wisconsin) at about 20.0% (w/w) total protein is diluted by addition and slow mixing to the water and fiber admixture. The admixture is mixed well, however care is taken to prevent air incorporation into the admixture, which causes the undesirable effect of foaming. Note that the concentration of whey protein in the aqueous whey protein preparation may vary between batches and/or manufacturers, and thus the amount of aqueous whey protein isolate and water added should be adjusted accordingly to achieve the desired final protein concentration in the finished beverage.

The pH of the admixture is checked, and if higher than 3.22 phosphoric acid is added at a rate of about 5 kg/minute with constant mixing with the endpoint being a target pH of about 3.2.

Approximately 0.39 kg of malic acid and approximately 0.39 kg of citric acid are added to the admixture and the pH is recorded after mixing well.

Approximately 81.24 grams of sucralose and approximately 154.75 grams of color, such as red color 2479 are added to the admixture. Alternatively, the sucralose and color may be premixed with approximately 1 kg or less of dietary fiber (mentioned above) to aid in dispersion and wetting of the sucralose and color.

Approximately 386.87 grams of natural pomegranate flavor (such as the natural pomegranate flavor available from Virginia Dare of Brooklyn, N.Y.) and approximately 773.74 grams of natural fruit punch flavor (such as the natural fruit punch flavor available from Virginia Dare of Brooklyn, N.Y.) are added to the admixture. After mixing well the pH is again recorded.

The bulk beverage is pasteurized in a manner common to the beverage and fruit juice industries known as “hot-fill”, where product is thermally processed in a continuous flow with a maximum temperature of 160-200° F. with a holding time at that maximum temperature ranging from 15 seconds to about 3 seconds. Product is cooled slightly to 160-185° F. just prior to being filled into glass or plastic containers designed for hot-fill.

### Example Six

The following example describes use of the aqueous protein ingredient for the production of approximately 385 liters of a water based, fruit-flavored protein beverage with a whey protein concentration of about 3.35%, approximately equal to the total protein concentration in bovine milk. The weight of the batch is approximately 387 kg.

Temperature should be maintained in the range of 40-50 degrees Fahrenheit during the acidification process.

Approximately 3.6 kg of dietary fiber (such as VitaSugar™ brand fiber, from Bio Neutra, located in Edmonton, Canada) is diluted by addition and slow mixing into approximately 315.6 kg of purified water. Alternatively, a small amount, such as approximately 1 kg or less, of the dietary fiber may be reserved to make a “premix” with other dry ingredients that are added in small amounts of less than 1 kg.

Approximately 64.8 kg of an aqueous whey protein isolate (such as the aqueous whey protein isolate available from Trega, located in Wisconsin) at about 20.0% (w/w) total protein is diluted by addition and slow mixing to the water and fiber admixture. The admixture is mixed well, however care is taken to prevent air incorporation into the admixture, which causes the undesirable effect of foaming. Note that the concentration of whey protein in the aqueous whey protein preparation may vary between batches and/or manufacturers, and thus the amount of aqueous whey protein isolate and water added should be adjusted accordingly to achieve the desired final protein concentration in the finished beverage.

The pH of the admixture is checked, and if higher than 3.22 phosphoric acid is added at a rate of about 5 kg/minute with constant mixing with the endpoint being a target pH of about 3.2.

Approximately 0.39 kg of malic acid and approximately 0.39 kg of citric acid are added to the admixture and the pH is recorded after mixing well.

Approximately 81.24 grams of sucralose and approximately 96.72 grams of color, such as purple color 2748 are added to the admixture. Alternatively, the sucralose and color may be premixed with approximately 1 kg or less of dietary fiber (mentioned above) to aid in dispersion and wetting of the sucralose and color.

Approximately 1160.6 grams of natural blueberry flavor (such as the natural blueberry flavor available from Virginia Dare of Brooklyn, N.Y.) and approximately 773.74 grams of natural raspberry flavor (such as the natural raspberry flavor available from Virginia Dare of Brooklyn, N.Y.) are added to the admixture. After mixing well the pH is again recorded.

The bulk beverage is pasteurized in a manner common to the beverage and fruit juice industries known as “hot-fill”, where product is thermally processed in a continuous flow with a maximum temperature of 160-200° F. with a holding time at that maximum temperature ranging from 15 seconds to about 3 seconds. Product is cooled slightly to 160-185° F. just prior to being filled into glass or plastic containers designed for hot-fill.

### Example Seven

The following example describes use of the aqueous protein ingredient for the production of approximately 385 liters of a water based, green tea-flavored protein beverage with a soy protein concentration of about 3.35. The weight of the batch is approximately 387 kg.

Temperature should be maintained in the range of 40-50 degrees Fahrenheit during the acidification process.

Approximately 3.6 kg of dietary fiber (such as VitaSugar™ brand fiber, from Bio Neutra, located in Edmonton, Canada) is diluted by addition and slow mixing into approximately 301.7 kg of purified water. Alternatively, a small amount, such as approximately 1 kg or less, of the dietary fiber may be reserved to make a “premix” with other dry ingredients that are added in small amounts of less than 1 kg.

Approximately 77.6 kg of an aqueous soy protein isolate at about 16.7% (w/w) total protein is diluted by addition and slow mixing to the water and fiber admixture. The admixture is mixed well, however care is taken to prevent air incorporation into the admixture, which causes the undesirable effect of foaming. Note that the concentration of soy protein in the aqueous soy protein preparation may vary between batches and/or manufacturers, and thus the amount of aqueous soy protein isolate and water added should be adjusted accordingly to achieve the desired final protein concentration in the finished beverage.

The pH of the admixture is checked, and if higher than 6.0 phosphoric acid is added at a rate of about 5 kg/minute with constant mixing with the endpoint being a target pH of about 5.75.

Approximately 0.39 kg of citric acid is added to the admixture and the pH is recorded after mixing well.

Approximately 127.7 grams of Lo Han Guo sweetener is added to the admixture. Alternatively, the Lo Han Guo sweetener may be premixed with approximately 1 kg or less of dietary fiber (mentioned above) to aid in dispersion and wetting of the Lo Han Guo.

Approximately 2.32 kg of natural green tea flavor (such as the natural green tea flavor available from Virginia Dare of Brooklyn, N.Y.), approximately 773.74 grams of natural black tea flavor (such as the natural black tea flavor available from Virginia Dare of Brooklyn, N.Y.), and approximately 386.87 grams of natural lemongrass flavor (such as the natural lemongrass flavor available from Virginia Dare of Brooklyn, N.Y.) are added to the admixture. After mixing well the pH is again recorded.

The bulk beverage is pasteurized in a manner common to the beverage and fruit juice industries known as “hot-fill”, where product is thermally processed in a continuous flow with a maximum temperature of 160-200° F. with a holding time at that maximum temperature ranging from 15 seconds to about 3 seconds. Product is cooled slightly to 160-185° F. just prior to being filled into glass or plastic containers designed for hot-fill.

### Example Eight

The following example describes use of the aqueous protein ingredient for the production of approximately 19400 kilograms of an orange and mango flavored water based protein beverage with a whey protein concentration of approximately 5%.

Temperature should be maintained in the range of 20-25 degrees Celsius during the acidification process.

4811.24 kg of Trega Pre-acidified Aqueous Whey Protein Isolate at 20% (w/w) total protein was diluted by addition and slow mixing of 14492.42 kg of water.

Approximately 4.85 kg malic acid was added with constant mixing.

Flavors, colors, preservative, and sweeteners were added as follows: 4074.04 g sucralose sweetener, 291 g Sensient #8006 Dry Yellow #6 (orange color), 11.64 kg potassium benzoate, 15520.14 g VDare Orange PB26 natural flavor, and 31040.28 g VDare Mango SW45 natural flavor.

Final pH of 2.95 to 3.10 was achieved by addition of approximately 29.10 kg citric acid.

The bulk beverage was pasteurized in a manner common to the beverage and fruit juice industries known as “hot-fill”, where product is thermally processed in a continuous flow with a maximum temperature of 160-200 degrees Fahrenheit with a holding time at that maximum temperature ranging from about 15 seconds to about 3 seconds. Product is cooled slightly to 160-185 degrees Fahrenheit just prior to being filled into glass or plastic containers designed for hot-fill.

### Example Nine

The following example describes use of the aqueous protein ingredient for the production of approximately 19400 kilograms of a grape flavored water based protein beverage with a whey protein concentration of approximately 5%.

Temperature should be maintained in the range of 20-25 degrees Celsius during the acidification process.

4811.24 kg of Trega Pre-acidified Aqueous Whey Protein Isolate at 20% (w/w) total protein was diluted by addition and slow mixing of 14522.49 kg of water.

Approximately 19.4 kg tartaric acid was added with constant mixing.

Flavors, colors, preservative, and sweeteners were added as follows: 4074.04 g sucralose sweetener, 232.80 g Sensient #7700 Dry Red #40 (red color), 11.64 kg potassium benzoate, 21340.19 g VDare Grape CS10 flavor, and 58.20 g Sensient #5601 Dry Blue #1 (blue color).

Final pH of 3.0 to 3.10 was achieved by addition of approximately 9.70 kg citric acid.

The bulk beverage was pasteurized in a manner common to the beverage and fruit juice industries known as “hot-fill”, where product is thermally processed in a continuous flow with a maximum temperature of 160-200 degrees Fahrenheit with a holding time at that maximum temperature ranging from about 15 seconds to about 3 seconds. Product is cooled slightly to 160-185 degrees Fahrenheit just prior to being filled into glass or plastic containers designed for hot-fill.

### Example Ten

The following example describes use of the aqueous protein ingredient for the production of approximately 19400 kilograms of a tropical fruit flavored water based protein beverage with a whey protein concentration of approximately 5%.

4811.24 kg of Trega Pre-acidified Aqueous Whey Protein Isolate at 20% (w/w) total protein was diluted by addition and slow mixing of 14519.67 kg of water.

Flavors, colors, preservative, and sweeteners were added as follows: 4074.04 g sucralose sweetener, 194 g Sensient #7700 Dry Red #40 (red color), 11.64 kg potassium benzoate, 14550.13 g VDare Punch AN28 liquid natural flavor, and 9700.09 g VDare Punch AN27 dry flavor.

Final pH of 2.95 to 3.10 was achieved by addition of approximately 29.10 kg citric acid.

The bulk beverage was pasteurized in a manner common to the beverage and fruit juice industries known as “hot-fill”, where product is thermally processed in a continuous flow with a maximum temperature of 160-200 degrees Fahrenheit with a holding time at that maximum temperature ranging from about 15 seconds to about 3 seconds. Product is cooled slightly to 160-185 degrees Fahrenheit just prior to being filled into glass or plastic containers designed for hot-fill.

### Example Eleven

The following example describes use of the aqueous protein ingredient for the production of approximately 3880 kilograms of an orange and mango flavored water based protein beverage with a whey protein concentration of approximately 3.3%.

Temperature should be maintained in the range of 20-25 degrees Celsius during the acidification process.

604.56 kg of Trega Aqueous Whey Protein Isolate at 21.50% (w/w) total protein was diluted by addition and slow mixing of 3218.57 kg of water.

Approximately 1.164 kg malic acid was added with constant mixing.

Flavors, colors, preservative, fiber, and sweeteners were added as follows: 795.41 g sucralose sweetener, 232.80 g Colormaker Orange 2733 annatto powder, 2716.02 g potassium benzoate, 36.86 kg VitaSugar fiber, 3104.03 g VDare Orange PB26 natural flavor, and 6208.06 g VDare Mango SW45 natural flavor.

Final pH of 2.95 to 3.05 was achieved by addition of approximately 5.82 kg citric acid.

The bulk beverage was pasteurized in a manner common to the beverage and fruit juice industries known as “hot-fill”, where product is thermally processed in a continuous flow with a maximum temperature of 160-200 degrees Fahrenheit with a holding time at that maximum temperature ranging from about 15 seconds to about 3 seconds. Product is cooled slightly to 160-185 degrees Fahrenheit just prior to being filled into glass or plastic containers designed for hot-fill.

### Example Twelve

The following example describes use of the aqueous protein ingredient for the production of approximately 3880 kilograms of a pomegranate flavored water based protein beverage with a whey protein concentration of approximately 3.3%.

Temperature should be maintained in the range of 20-25 degrees Celsius during the acidification process.

604.56 kg of Trega Aqueous Whey Protein Isolate at 21.50% (w/w) total protein was diluted by addition and slow mixing of 3216.11 kg of water.

Approximately 2.716 kg malic acid was added with constant mixing.

Flavors, colors, preservative, fiber, and sweeteners were added as follows: 776.01 g sucralose sweetener, 388.0 g Colormaker Purple Carrot 2748 powder, 1552 g Colormaker Red Cabbage 2714 powder, 2716.02 g potassium benzoate, 36.86 kg VitaSugar fiber, 3880.04 g VDare Pomegranate natural flavor, and 7760.07 g VDare Fruit Punch natural flavor.

Final pH of 2.95 to 3.05 was achieved by addition of approximately 2.716 kg citric acid.

The bulk beverage was pasteurized in a manner common to the beverage and fruit juice industries known as “hot-fill”, where product is thermally processed in a continuous flow with a maximum temperature of 160-200 degrees Fahrenheit with a holding time at that maximum temperature ranging from about 15 seconds to about 3 seconds. Product is cooled slightly to 160-185 degrees Fahrenheit just prior to being filled into glass or plastic containers designed for hot-fill.

### Example Thirteen

The following example describes use of the aqueous protein ingredient for the production of approximately 3880 kilograms of a blueberry and raspberry flavored water based protein beverage with a whey protein concentration of approximately 3.3%.

Temperature should be maintained in the range of 20-25 degrees Celsius during the acidification process.

604.56 kg of Trega Aqueous Whey Protein Isolate at 21.50% (w/w) total protein was diluted by addition and slow mixing of 3210.67 kg of water.

Approximately 1.552 kg malic acid was added with constant mixing.

Flavors, colors, preservative, fiber, and sweeteners were added as follows: 776.01 g sucralose sweetener, 1940.02 g Colormaker Red Cabbage 2714 powder, 2716.02 g potassium benzoate, 36.86 kg VitaSugar fiber, 11640.11 g VDare Blueberry natural flavor, and 7760.07 g VDare Raspberry natural flavor.

Final pH of 3.05 to 3.15 was achieved by addition of approximately 1.552 kg citric acid.

The bulk beverage was pasteurized in a manner common to the beverage and fruit juice industries known as “hot-fill”, where product is thermally processed in a continuous flow with a maximum temperature of 160-200 degrees Fahrenheit with a holding time at that maximum temperature ranging from about 15 seconds to about 3 seconds. Product is cooled slightly to 160-185 degrees Fahrenheit just prior to being filled into glass or plastic containers designed for hot-fill.

### Example Fourteen

The following example describes use of the aqueous protein ingredient for the production of approximately 3860 kilograms of a cranberry and apple flavored water based protein beverage with a whey protein concentration of approximately 1.04%.

Temperature should be maintained in the range of 20-25 degrees Celsius during the acidification process.

200.778 kg of Trega Aqueous Whey Protein Isolate at 20.0% (w/w) total protein was diluted by addition and slow mixing of 3589.67 kg of water.

Approximately 2.317 kg malic acid was added with constant mixing.

Flavors, colors, fiber, and sweeteners were added as follows: 772.22 g sucralose sweetener, 3861.11 g Mastertast freeze-dried Cranberry Fruit powder, 772.22 g Colormaker Purple Carrot 2748 powder, 772.22 g Colormaker Red Cabbage 2714 powder, 44.40 kg VitaSugar fiber, 11583.32 g VDare Cranberry BX09 natural flavor, and 5019.44 g VDare Apple AU02 natural flavor.

Final pH of 3.05 to 3.15 was achieved by addition of approximately 1158.33 g Ascorbic acid.

The bulk beverage was pasteurized in a manner common to the beverage and fruit juice industries known as “hot-fill”, where product is thermally processed in a continuous flow with a maximum temperature of 160-200 degrees Fahrenheit with a holding time at that maximum temperature ranging from about 15 seconds to about 3 seconds. Product is cooled slightly to 160-185 degrees Fahrenheit just prior to being filled into glass or plastic containers designed for hot-fill.

### Example Fourteen

The following example describes use of the aqueous protein ingredient for the production of approximately 3880 kilograms of an orange and mango flavored water based protein beverage with a whey protein concentration of approximately 3.3%.

Temperature should be maintained in the range of 20-25 degrees Celsius during the acidification process.

604.56 kg of Trega Aqueous Whey Protein Isolate at 21.50% (w/w) total protein was diluted by addition and slow mixing of 3218.57 kg of water.

Approximately 1.164 kg malic acid was added with constant mixing.

Flavors, colors, preservative, fiber, and sweeteners were added as follows: 795.41 g sucralose sweetener, 232.80 g Colormaker Orange 2733 annatto powder, 2716.02 g potassium benzoate, 36.86 kg VitaSugar fiber, 3104.03 g VDare Orange PB26 natural flavor, and 6208.06 g VDare Mango SW45 natural flavor.

Final pH of 2.95 to 3.05 was achieved by addition of approximately 5.82 kg citric acid.

The bulk beverage was pasteurized in a manner common to the beverage and fruit juice industries known as “hot-fill”, where product is thermally processed in a continuous flow with a maximum temperature of 160-200 degrees Fahrenheit with a holding time at that maximum temperature ranging from about 15 seconds to about 3 seconds. Product is cooled slightly to 160-185 degrees Fahrenheit just prior to being filled into glass or plastic containers designed for hot-fill.

### Example Fifteen

The following example describes use of the aqueous protein ingredient for the production of approximately 3860 kilograms of blueberry and raspberry flavored water based protein beverage with a whey protein concentration of approximately 1.04%.

Temperature should be maintained in the range of 20-25 degrees Celsius during the acidification process.

186.77 kg of Trega Aqueous Whey Protein Isolate at 21.50% (w/w) total protein was diluted by addition and slow mixing of 3600.98 kg of water.

Approximately 1.544 kg malic acid was added with constant mixing.

Flavors, colors, fiber, and sweeteners were added as follows: 772.22 g sucralose sweetener, 3861.11 g Mastertaste freeze dried Raspberry Fruit 705353 powder, 1930.55 g Colormaker Red Cabbage 2714 powder, 44.403 kg VitaSugar fiber, 11583.32 g VDare Blueberry natural flavor, and 7722.22 g VDare Raspberry natural flavor.

Final pH of 3.05 to 3.15 was achieved by addition of approximately 1.544 kg citric acid.

The bulk beverage was pasteurized in a manner common to the beverage and fruit juice industries known as “hot-fill”, where product is thermally processed in a continuous flow with a maximum temperature of 160-200 degrees Fahrenheit with a holding time at that maximum temperature ranging from about 15 seconds to about 3 seconds. Product is cooled slightly to 160-185 degrees Fahrenheit just prior to being filled into glass or plastic containers designed for hot-fill.

While particular embodiments of the present invention have been disclosed, it is to be understood that various different modifications are possible and are contemplated within the true spirit and scope of the appended claims. There is no intention, therefore, of limitations to the exact abstract, examples, or disclosure herein presented.

We claim:

1. A protein beverage composition suitable for human consumption, comprising: protein essentially free of caseinate and derived from an aqueous protein isolate collected from membrane-filtration isolation of the protein and without substantial drying; and, wherein said protein beverage composition exhibits a pH ranging from about 2.0 to about 4.6, whereby substantial solubility of the protein is maintained in the beverage composition, and wherein said protein beverage is essentially free of active microbes known to be harmful to human health, both at the time of packaging of the protein beverage and for a time period of at least one year after packaging.

2. A protein beverage composition in accordance with claim 1, wherein said protein beverage composition is carbonated.

3. A protein beverage composition in accordance with claim 1, wherein said protein beverage composition contains about 0% to about 98% juice.

4. A protein beverage composition in accordance with claim 1, or claim 2, or claim 3, wherein said aqueous protein isolate is aqueous whey protein isolate.

5. A protein beverage in accordance with claim 1, or claim 2, or claim 3, wherein said beverage comprises at least one additional ingredient selected from the group consisting of a concentrated plant extract, an anti-foaming agent, a nutrient, calcium or a calcium derivative, an energy-generating additive, an herbal supplement, a flavoring agent, a sweetener, a preservative, and a coloring agent.

6. A protein beverage in accordance with claim 1, or claim 2, or claim 3, wherein said carbonated protein beverage is clear or transparent in color, exhibiting essentially no turbidity.

7. A protein beverage in accordance with claim 5, wherein said energy-generating additive is selected from the group consisting of caffeine, citrulline malate, a magnesium-containing compound, and combinations thereof.

8. A protein beverage in accordance with claim 7, wherein said magnesium-containing compound is selected from the group consisting of magnesium aspartate, magnesium oxide, magnesium lactate, magnesium citrate, magnesium carbonate, magnesium gluconate, magnesium orotate, magnesium chloride, magnesium hydroxide, magnesium phosphate, magnesium sulfate, and combinations thereof.

9. A protein beverage composition in accordance with claim 5, wherein said concentrated plant extract has a high nutritional content.

10. A protein beverage composition in accordance with claim 5, wherein said concentrated plant extract contributes negligibly to the overall calorie content of the protein beverage.

11. A protein beverage composition in accordance with claim 1, or claim 2, or claim 3, wherein said aqueous protein isolate is selected from the group consisting of whey protein, casein, lactalbumin, serum albumin, glycomacropeptide, soy protein, rice protein, pea protein, canola protein, wheat protein, hemp protein, zein, flax protein, egg white protein, ovalbumin, gelatin protein, and combinations thereof.

12. A protein beverage composition in accordance with claim 1, or claim 2, or claim 3, wherein said protein beverage further comprises about 0% alcohol by volume to about 15% alcohol by volume.

13. A method of preparing a protein beverage, comprising: admixing an aqueous protein isolate, collected from membrane-filtration isolation of the protein without substantial drying and with a pH adjusting agent to provide a pH of between about 2 and about 4.6, thereby obtaining an admixture.

14. A method in accordance with claim 13, wherein carbonation is added to said admixture to prepare a carbonated protein beverage.

15. A method in accordance with claim 13, wherein juice is added to said admixture to achieve a concentration of about 0% by weight to about 98% by weight of the admixture.

16. A method in accordance with claim 13, or claim 14, or claim 15, wherein said aqueous protein isolate is an aqueous whey protein isolate.

17. A method in accordance with claim 13, or claim 14, or claim 15, wherein additional ingredients are admixed into said admixture, and said additional ingredients include at least one ingredient selected from the group consisting of a concentrated plant extract, an anti-foaming agent, a nutrient, calcium or a calcium derivative, an energy-generating additive, an herbal supplement, a flavoring agent, a sweetener, a preservative, and a coloring agent.

18. A method in accordance with claim 17, wherein said energy-generating additive is selected from the group consisting of caffeine, citrulline malate, a magnesium-containing compound, and combinations thereof.

19. A method in accordance with claim 18, wherein said magnesium-containing compound is selected from the group consisting of magnesium aspartate, magnesium oxide, magnesium lactate, magnesium citrate, magnesium carbonate, magnesium gluconate, magnesium orotate, magnesium chloride, magnesium hydroxide, magnesium phosphate, magnesium sulfate, and combinations thereof.

20. A method in accordance with claim 13, or claim 14, or claim 15, wherein said protein beverage is clear or transparent in color, exhibiting essentially no turbidity.

21. A method in accordance with claim 17, wherein said concentrated plant extract has a high nutritional content.

22. A method in accordance with claim 17, wherein said concentrated plant extract contributes negligibly to the overall calorie content of the protein beverage.

23. A method in accordance with claim 13, or claim 14, or claim 15, wherein said aqueous protein isolate is selected from the group consisting of whey protein, casein, lactalbumin, serum albumin, glycomacropeptide, soy protein, rice protein, pea protein, canola protein, wheat protein, hemp protein, zein, flax protein, egg white protein, ovalbumin, gelatin protein, and combinations thereof.

24. A method in accordance with claim 13, or claim 14, or claim 15, wherein alcohol is added to the admixture, to prepare an about 0% alcohol by volume to about 15% alcohol by volume protein beverage.

25. A protein beverage concentrate composition suitable for dilution to generate a beverage suitable for human consumption, comprising:
about 0% by weight to about 60% by weight juice concentrate, wherein said juice concentrate has a Brix value of about 20° Brix to about 75° Brix;
about 0.02% by weight to about 75% by weight protein, derived from an aqueous protein isolate collected from membrane-filtration isolation of the protein and without substantial drying; and
wherein both, at the time of packaging of the protein beverage concentrate and during subsequent storage without refrigeration, substantial solubility of the protein is maintained in the protein beverage concentrate, and wherein said protein beverage concentrate is essentially free of pathogenic microbes known to be harmful to human health, both at the time of packaging of the protein beverage concentrate and during subsequent storage.

26. A protein beverage concentrate in accordance with claim 25, wherein said protein beverage concentrate ranges from about a two-fold concentrate to about a twenty-five-fold concentrate.

27. A protein beverage concentrate in accordance with claim 26, wherein said protein beverage concentrate is about a five-fold concentrate.

28. A protein beverage concentrate in accordance with claim 26, wherein one part of said protein beverage concentrate is diluted with four parts liquid to prepare a protein beverage suitable for human consumption.

29. A protein beverage concentrate in accordance with claim 28, wherein said liquid is water, fruit juice, vegetable juice, tea, alcohol, coffee, milk, soy milk, rice milk, almond milk, or combinations thereof.

30. A protein beverage concentrate in accordance with claim 28, wherein said liquid contains carbonation.

31. A protein beverage concentrate in accordance with claim 28, wherein said protein beverage contains carbonation.

32. A protein beverage concentrate in accordance with claim 25, wherein said aqueous protein isolate is derived from whey protein, casein, lactalbumin, serum albumin, glycomacropeptide, soy protein, rice protein, pea protein, canola protein, wheat protein, hemp protein, zein, flax protein, egg white protein, ovalbumin, gelatin protein, or combinations thereof.

33. A protein beverage concentrate in accordance with claim 25, wherein said essentially free from active microbe condition is created by the inactivation of microbes by pasteurization, aseptic packaging, carbonation, ozonation, radiation, ultra violet light, high pressure processing, membrane permeation, pulsed electric field, sonication, or combinations thereof.

34. A protein beverage concentrate in accordance with claim 25, further comprising about 0% by weight to about 100% by weight filler.

35. A protein beverage concentrate in accordance with claim 34, wherein said filler comprises at least one additional ingredient selected from the group including water, a sweetener, a flavoring agent, a coloring agent, an anti-foaming agent, a nutrient, calcium or a calcium derivative, an energy-generating additive, an herbal supplement, a concentrated plant extract, and a preservative.

36. A protein beverage concentrate in accordance with claim 35, wherein said energy generating additive is caffeine, citrulline malate, a magnesium-containing compound, or a combination thereof.

37. A protein beverage concentrate in accordance with claim 25, wherein said protein beverage concentrate may be used by an individual, in a food services beverage dispenser, or in a bottling plant.

38. A protein beverage concentrate in accordance with claim 25, wherein said protein beverage concentrate is a protein beverage concentrated syrup.

39. A protein beverage concentrate in accordance with claim 25, wherein said protein beverage concentrate is dried to form a protein juice beverage concentrated powder by lyophilization (freeze drying), spray drying, fluid bed drying, drum drying, or combinations thereof.

40. A method of making a protein beverage concentrate composition suitable for dilution to generate a beverage suitable for human consumption, comprising:
admixing a juice concentrate having a Brix value of about 20° Brix to about 75° Brix, to achieve a percent by weight of juice concentrate of about 0% by weight to about 60% by weight juice, and a protein, derived from an aqueous protein isolate collected from membrane-filtration isolation of the protein and without substantial drying, to achieve a percent by weight of protein in the admixture of about 0.02% by weight to about 75% by weight, thereby obtaining an admixture; and
packaging said protein beverage concentrate in a container which may be stored at room temperature.

41. A method of making a protein beverage concentrate in accordance with claim 40, wherein said protein beverage concentrate ranges from about a two-fold concentrate to about a twenty-five-fold concentrate.

42. A method of making a protein beverage concentrate in accordance with claim 41, wherein said protein beverage concentrate is about a five-fold concentrate.

43. A method of making a protein beverage concentrate in accordance with claim 40, wherein one part of said protein beverage concentrate is diluted with four parts liquid to prepare a protein beverage suitable for human consumption.

44. A method of making a protein beverage concentrate in accordance with claim 43, wherein said liquid is water, fruit juice, vegetable juice, tea, alcohol, coffee, milk, soy milk, rice milk, almond milk, or combinations thereof.

45. A method of making a protein beverage concentrate in accordance with claim 43, wherein said liquid contains carbonation.

46. A method of making a protein beverage concentrated syrup in accordance with claim 43, wherein said protein beverage contains carbonation.

47. A method of making a protein beverage concentrate in accordance with claim 40, wherein said aqueous protein isolate is derived from whey protein, casein, lactalbumin, serum albumin, glycomacropeptide, soy protein, rice protein, pea protein, canola protein, wheat protein, hemp protein, zein, flax protein, egg white protein, ovalbumin, gelatin protein, or combinations thereof.

48. A method of making a protein beverage concentrate in accordance with claim 40, further comprising admixing a filler to achieve a percent by weight of filler in the admixture of about 0% by weight to about 100%.

49. A method of making a protein beverage concentrate in accordance with claim 48, wherein said filler comprises at least one additional ingredient selected from the group including water, a sweetener, a flavoring agent, a coloring agent, an anti-foaming agent, a nutrient, calcium or a calcium derivative, an energy-generating additive, an herbal supplement, a concentrated plant extract, and a preservative.

50. A method of making a protein beverage concentrate in accordance with claim 49, wherein said energy generating additive is caffeine, citrulline malate, a magnesium-containing compound, or a combination thereof.

51. A method of making a protein beverage concentrate in accordance with claim 40, wherein said protein beverage concentrate may be used by an individual, in a food services beverage dispenser, or in a bottling plant.

52. A method of making a protein beverage concentrate in accordance with claim 40, wherein said protein beverage concentrate is a protein beverage concentrated syrup.

53. A method of making a protein beverage concentrate in accordance with claim 40, wherein said protein beverage concentrate is dried to form a protein juice beverage concentrated powder by lyophilization (freeze drying), spray drying, fluid bed drying, drum drying, or combinations thereof.

54. A method of making a protein beverage concentrated syrup in accordance with claim 40, wherein said protein beverage concentrate is diluted with a liquid to prepare a protein beverage suitable for human consumption.

55. A method of making a protein beverage concentrate in accordance with claim 54, wherein said liquid is water, fruit juice, vegetable juice, tea, alcohol, coffee, milk, soy milk, rice milk, almond milk, or combinations thereof.

56. A method of making a protein beverage concentrate in accordance with claim 54, wherein said liquid contains carbonation.

57. A method of making a protein beverage concentrate in accordance with claim 54, wherein said protein beverage contains carbonation.

58. A whey protein beverage comprising:
about 0.01% by weight to about 15% by weight whey protein derived from an aqueous protein isolate collected from membrane-filtration isolation of the protein and without substantial drying, and a balance of water;
wherein both at the time of packaging of the whey protein beverage and during any subsequent storage without refrigeration for a time period of at least one year after packaging, substantial solubility of the whey protein is maintained in said protein beverage and said protein beverage is substantially free of pathogenic microbes.

59. The whey protein beverage according to claim 58 that is essentially free from pathogenic microbes created by the inactivation of microbes in the individual container in which said whey protein beverage is packaged.

60. The whey protein beverage according to claim 58, wherein any pathogenic microbes are inactivated using a timed temperature condition of the whey protein beverage, while said whey protein beverage is contained in an individual container.

61. The whey protein beverage according to claim 58, wherein any pathogenic microbes of the whey protein beverage are inactivated using exposure to elevated temperature, radiation, or a combination thereof.

62. The whey protein beverage according to claim 58, wherein said beverage comprises at least one additional ingredient selected from the group including concentrated plant extract, an anti-foaming agent, a nutrient, calcium or a calcium derivative, an energy-generating additive, an herbal supplement, a flavoring agent, a sweetener, a preservative, and a coloring agent.

63. A protein beverage composition in accordance with claim 1 or claim 2, wherein said protein beverage composition contains about 0.01% by weight to about 15% by weight protein and a balance of water.

64. A protein beverage composition in accordance with claim 63, wherein said protein beverage composition contains about 0.01% by weight to about 8% by weight protein and a balance of water.

65. A method in accordance with claim 13 or claim 14, wherein said protein beverage contains about 0.01% by weight to about 15% by weight protein and a balance of water.

66. A method in accordance with claim 65, wherein said protein beverage contains about 0.01% by weight to about 8% by weight protein and a balance of water.

67. A protein beverage comprising:
about 0.01% by weight to about 15% by weight protein, derived from an aqueous protein isolatecollected from membrane-filtration isolation of the protein and without substantial drying, and a balance of water;
wherein both at the time of packaging of the protein beverage and during any subsequent storage without refrigeration for a time period of at least 18 months after packaging, substantial solubility of the protein is maintained in said protein beverage and said protein beverage is substantially free of pathogenic microbes.

68. A protein beverage according to claim 67, wherein said aqueous protein isolate is selected from the group consisting of whey protein, soy protein, casein, lactalbumin, serum albumin, glycomacropeptide, rice protein, pea protein, canola protein, wheat protein, hemp protein, zein, flax protein, egg white protein, ovalbumin, gelatin protein, and combinations thereof.

69. A protein beverage according to claim 67, wherein said protein beverage further comprises
about 0% by weight to about 1.5% by weight flavor;
about 0% by weight to about 0.5% by weight sweetener;
about 0% by weight to about 0.5% by weight acidulent;
about 0% by weight to about 0.1% by weight color; and
about 0% by weight to about 1.5% by weight dietary fiber.

70. A protein beverage according to claim 67, wherein said protein beverage further comprises at least one additional ingredient selected from the group consisting of a concentrated plant extract, an anti-foaming agent, a nutrient, calcium or a calcium derivative, an energy-generating additive, an herbal supplement, a flavoring agent, a sweetener, a preservative, and a coloring agent.

71. A method of preparing a protein beverage, comprising: admixing an aqueous protein isolate collected from membrane-filtration isolation of the protein and without substantial drying, with water and a pH adjusting agent to provide a pH of between about 3.0 and about 6.0, thereby obtaining an admixture.

72. A method of preparing a protein beverage according to claim 71, wherein said aqueous protein isolate is selected from the group consisting of whey protein, soy protein, casein, lactalbumin, serum albumin, glycomacropeptide, rice protein, pea protein, canola protein, wheat protein, hemp protein, zein, flax protein, egg white protein, ovalbumin, gelatin protein, and combinations thereof.

73. A method of preparing a protein beverage according to claim 71, wherein said protein beverage further comprises
about 0% by weight to about 1.5% by weight flavor;
about 0% by weight to about 0.5% by weight sweetener;
about 0% by weight to about 0.5% by weight acidulent;
about 0% by weight to about 0.1% by weight color; and
about 0% by weight to about 1.5% by weight dietary fiber.

74. A method of preparing a protein beverage according to claim 71, wherein said protein beverage further comprises at least one additional ingredient selected from the group consisting of a concentrated plant extract, an anti-foaming agent, a nutrient, calcium or a calcium derivative, an energy-generating additive, an herbal supplement, a flavoring agent, a sweetener, a preservative, and a coloring agent.
